(19) United States
(12) Patent Application Publication
(10) Pub. No.: US 2019/0047535 A1
(43) Pub. Date: Feb. 14, 2019

(54) AIR ACTUATED BRAKE SYSTEM

(71) Applicant: Hendrickson USA, L.L.C., Itasca, IL (US)

(72) Inventors: R. Scott Fulton, Hudson, OH (US); Donald R. Hester, East Canton, OH (US); Benedetto A. Naples, Canton, OH (US); Matthew P. Karich, Fairlawn, OH (US)

(21) Appl. No.: 16/059,422

(22) Filed: Aug. 9, 2018

Related U.S. Application Data
(60) Provisional application No. 62/544,951, filed on Aug. 14, 2017.

(51) Int. Cl. B60T 17/04; B60T 13/26; B60T 17/06

(52) U.S. Cl. CPC B60T 17/04; B60T 1/065; B60T 17/06; B60T 13/268

(57) ABSTRACT

An air actuated brake system for use on a heavy-duty vehicle having a frame. Each of a first pair of air actuated brake assemblies is mounted to a first axle supported by the frame. Each of a second pair of air actuated brake assemblies is mounted to a second axle supported by the frame. A source of pressurized air is provided. Valve structure is in fluid communication with the source of pressurized air. The valve structure is located substantially central relative to each of the air actuated brake assemblies. Conduits of substantially equal length and/or volume fluidly connect the valve structure with the first pair of air actuated brake assemblies and with the second pair of air actuated brake assemblies to actuate the air actuated brake assemblies at substantially the same time.

### CROSS-REFERENCE TO RELATED APPLICATIONS

This application claims the benefit of U.S. Provisional Patent Application Ser. No. 62/544,951 filed on Aug. 14, 2017.

### TECHNICAL FIELD

The disclosed subject matter generally relates to vehicle braking systems. In particular, the disclosed subject matter relates to an air actuated brake system for a heavy-duty vehicle.

### BACKGROUND

Air actuated brake systems for heavy-duty vehicles are known. One type of air actuated brake system for a heavy-duty vehicle is an air disc brake system. The air disc brake system includes a plurality of brake assemblies. Each air actuated disc brake assembly operates by forcing a pair of opposing brake pads against a rotor to create friction between the pads and the rotor to effect slowing and/or stopping of the heavy-duty vehicle. The brake pads move against the rotor in response to pressurized air being supplied to the air actuated disc brake assembly.

Each air actuated disc brake assembly is operatively mounted on a respective end of one or more axles of the heavy-duty vehicle. Each air actuated disc brake assembly includes a caliper supported by a torque plate. The torque plate is connected to a respective end of the axle. The torque plate resists forces generated during braking.

The caliper has at least one bore for receiving one or more pistons associated with respective brake pads. The caliper also supports an actuator. The actuator is typically a brake air chamber in fluid communication with a source of pressurized air. The actuator causes movement of the piston(s) upon receiving pressurized air. Upon actuation, the piston(s) move the brake pads against a rotor in response to receiving pressurized air. The disc brake pads are forced against opposite sides of the rotor to slow and/or stop rotation of the rotor, thereby slowing and/or stopping the heavy-duty vehicle.

Air actuated brake systems, such as disc or drum brake systems, are used to control slowing and/or stopping of motor vehicles in an effective manner. In particular, air actuated brake systems are commonly used on heavy-duty vehicles such as trucks, trailers, and buses, which typically have relatively large gross vehicle weights. The considerable mass of these heavy-duty vehicles in combination with the high speeds at which they travel often require a brake system that responds rapidly and evenly with substantial braking power.

Known air actuated brake systems typically mount brake assemblies varying distances from a source of pressurized air. This creates brake air supply systems with increased packaging complexity. Suspension design types can have greatly varying conduit line lengths and/or volumes supplying air for activating each brake actuator of a respective brake assembly. For example, known air actuated brake systems used on a heavy-duty vehicle, such as a trailer, with two or more axles can have air conduit lines of varying lengths extending from a pressurized air supply distribution device or valve. For example, the known air actuated brake systems may have conduit lines with a length of about three feet (3′) to brake assemblies mounted on the nearest axle, and conduit line lengths of about seven feet (7′) to brake assemblies mounted on the next nearest axle. There can be even greater conduit line lengths to brake assemblies on any axle(s) located further from the pressurized air supply distribution device. The conduit lines typically have the same inner diameters and, thus different volumes.

The conduit lines are typically connected to a common pressurized air supply distribution device, such as a valve and/or manifold near the source of pressurized air. The volume of air in the different lengths of conduit lines causes less pressure being delivered to brake assemblies located further away from the common pressurized air supply distribution device than brake assemblies located nearer. The time it takes for the pressure in the various conduit lines to reach a pressure sufficient to actuate a particular brake assembly differs as a function of conduit line lengths and volumes. Thus, generally the brake assemblies located furthest from the common valve and/or manifold, and therefore having the longest conduit lines take a relatively longer time to actuate. This can lead to uneven application of the brake assemblies at least front-to-back, and possibly side-to-side if there are conduit lines with different lengths supplying brake assemblies located on the same axle.

Uneven application of braking can lead to uneven wear of brake assembly components and/or pulling to one side when brakes are applied. This is referred to as unbalanced braking which is generally less than optimal braking. Unbalanced braking can lead to accelerated and uneven wear of brake system components and thermal imbalance among the various brake assemblies. The known air actuated brake systems have rather complex routing and packaging of the conduit lines. The complex routing may cause interference with other components of the heavy-duty vehicle and/or hinder troubleshooting of the known air actuated brake system. Such complex routing may have relatively high cost and impede efficient assembly. The complex routing may also yield decreased conduit line clearance, increased conduit line wear and hinder caliper float.

Thus, a need exists for an air actuated brake system that provides better balanced braking than previously known air actuated brake systems.

### SUMMARY

A summary is provided to introduce concepts that are described below. This summary is not intended to identify key factors or essential features of the disclosed subject matter, nor is it intended to be used to limit the scope of the disclosed subject matter or claims.

A new and improved air actuated brake system, according to the subject disclosure, overcomes the limitations, disadvantages, drawbacks and deficiencies of previously known air actuated brake systems. The new and improved air actuated brake system provides relatively balanced braking compared to previously known air actuated brake systems. The new and improved air actuated brake system has conduit line lengths that are shortened and/or substantially equal. The new and improved air actuated brake system also has conduit line volumes that are substantially equal. The new and improved air actuated brake system delivers substantially equal pressure at substantially the same time to actuators of the air actuated brake system to provide substantially balanced braking. The new and improved air actuated brake system, thus, can provide relatively even wear of brake system components and/or can eliminate or reduce pulling to one side when brakes are applied.

These improvements and features lead to relatively even timing of actuating the brake assemblies, which generally results in less wear of brake system components and a thermally balanced brake system. A shortening of conduit line lengths and equalizing conduit line lengths, volumes and complexity also reduces component and assembly costs. The air actuated brake system offers reduced routing complexity and packaging of the conduit lines. Reduced complexity of conduit line routing may advantageously avoid interference with other components of the heavy-duty vehicle and occupy less valuable space beneath the heavy-duty vehicle. The simplified routing reduces interference with troubleshooting of the brake system and/or other components of the heavy-duty vehicle. The simplified conduit line routing can be less costly because of relatively less material use and is relatively easy to assemble and install. The simplified routing may also increase conduit line clearance, decrease conduit line wear and provide better caliper float.

The new and improved air actuated brake system is intended for use on a heavy-duty vehicle having a frame. Each of a first pair of air actuated brake assemblies is mounted to a respective end portion of a first axle that is supported by the frame of the heavy-duty vehicle. Each of a second pair of air actuated brake assemblies is mounted to a respective end portion of a second axle that is also supported by the frame. A source of pressurized air is provided. Valve structure is in fluid communication with the source of pressurized air. The valve structure is located substantially equidistant to each of the air actuated brake assemblies and near the source of pressurized air. Each of a plurality of conduits of substantially equal length and/or volumes fluidly connects the valve structure with respective ones of the first pair of air actuated brake assemblies and with respective ones of the second pair of air actuated brake assemblies to actuate the air actuated brake assemblies. Each of the conduits have substantially equal inner diameters.

The new and improved air actuated brake system delivers substantially equal pressurized air to each of the air actuated brake assemblies at substantially the same time to balance braking action. The frame supporting the first and second axles may be a slider box assembly, a primary frame or subframe. Each of the air actuated brake assemblies may be a disc brake assembly. Each of the air actuated brake assemblies may be a drum brake assembly.

### DRAWINGS

The following description and drawings set forth certain illustrative aspects and implementations of the disclosed subject matter. These are indicative of but a few of the various ways in which one or more aspects and implementations of the disclosed subject matter may be employed. Further features will become apparent to those reading the following description with reference to the accompanying drawings, in which:

FIG. 1 is a plan view of a slider box assembly for a heavy-duty vehicle, viewed from below, having a prior art air actuated brake system;

FIG. 2 is a perspective view of frame structure for a heavy-duty vehicle illustrating a representative slider box assembly, viewed from above, incorporating an air actuated brake system according to an aspect of the subject disclosure;

FIG. 3 is a perspective view of the slider box assembly illustrated in FIG. 2, viewed from below;

FIG. 4 is a plan view of the slider box assembly illustrated in FIGS. 2 and 3, viewed from above;

FIG. 5 is a plan view of the slider box assembly illustrated in FIGS. 2-4, viewed from below; and

FIG. 6 is a rear elevation view of the slider box assembly illustrated in FIGS. 2-5, illustrating a portion of the air actuated brake system.

### DESCRIPTION

The disclosed subject matter is described with reference to the drawings, in which like reference characters are used to refer to like elements throughout the description. In the description, numerous specific details are set forth to provide an understanding of the disclosed subject matter. It will be understood, however, that the concepts of the disclosed subject matter can be practiced without these specific details.

A new and improved air actuated brake system for a heavy-duty vehicle, according to an aspect of the disclosed subject matter, overcomes disadvantages, limitations, drawbacks and deficiencies associated with previously known air actuated brake systems. The air actuated brake system, according to the subject disclosure, provides relatively balanced braking compared to previously known air actuated brake systems. The air actuated brake system has distribution valve structure located substantially equidistant to all brake assemblies. The air actuated brake system also has conduit line lengths that are relatively short and substantially equal to help provide balanced braking. The air actuated brake system of the subject disclosure further has conduit line volumes and/or pressures that are substantially equal to help provide balanced braking.

These features lead to relatively even timing of actuating the brake assemblies, or balanced braking, which generally results in less wear of brake components and yields a thermally balanced brake system. A shortening of conduit line lengths and/or substantially equalizing conduit line lengths, volumes and complexity also reduces component and assembly costs. The air actuated brake system of the subject disclosure offers reduced routing complexity and packaging of the conduit lines. Reduced complexity of conduit line routing may advantageously avoid interference with other components of the heavy-duty vehicle and occupy less valuable space beneath the heavy-duty vehicle. Substantially equal conduit line lengths and volumes further may minimize or eliminate the opportunity for caliper restriction in an air disc brake system. The simplified routing provides less interference with troubleshooting the brake system. The simplified routing also increases conduit line clearance and decreases conduit line wear.

A new and improved air actuated brake system for a heavy-duty vehicle is constructed according to an aspect of the disclosed subject matter and is presented by way of example. The new and improved air actuated brake system is intended for use on a heavy-duty vehicle in which the heavy-duty vehicle has a frame. Each of a first pair of air actuated brake assemblies is mounted to a respective end portion of a first axle that is supported by the frame. Each of a second pair of air actuated brake assemblies is mounted to a respective end portion of a second axle that is also supported by the frame. The heavy-duty vehicle has a source of pressurized air with an outlet. Valve structure is adjacent to the outlet of the source of pressurized air and is in fluid communication with the source of pressurized air. The valve structure is located substantially equidistant to, or centrally among, each of the air actuated brake assemblies.

A plurality of conduits of substantially equal length and volume fluidly connect the valve structure with each of the air actuated brake assemblies. The air actuated brake system may have substantially equal pressurized air supplied to each of the air actuated brake assemblies at substantially the same time to balance braking action. The air actuated brake system may have a substantially equal volume of pressurized air supplied to each of the air actuated brake assemblies at substantially the same time to balance braking action. Each of the air actuated brake assemblies may be a disc brake assembly. Each of the air actuated brake assemblies may be a drum brake assembly.

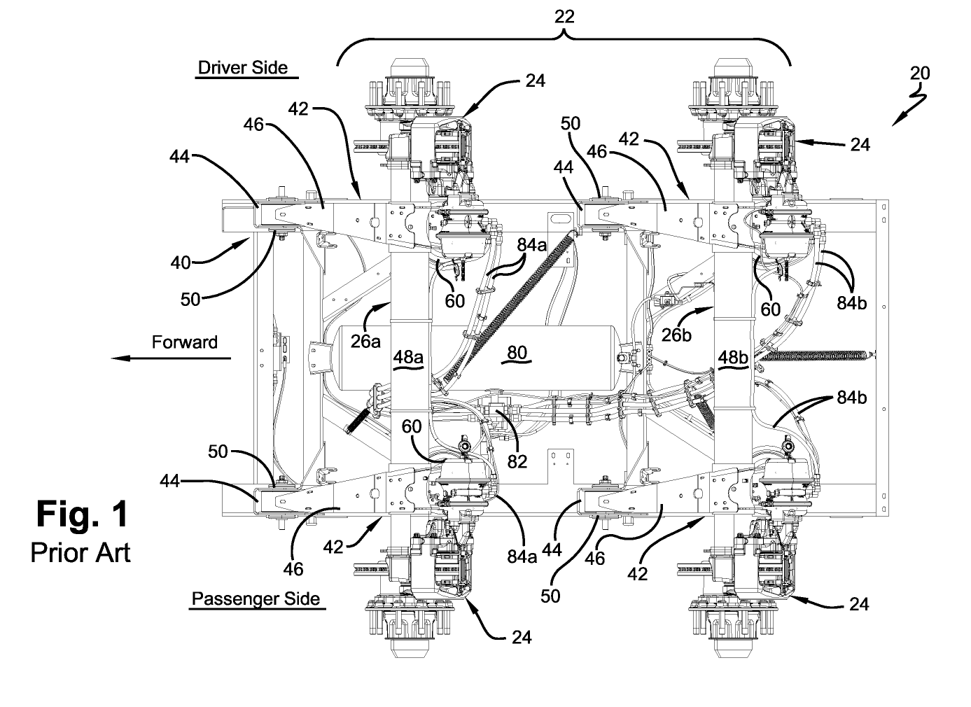

In order to understand the environment in which the new and improved air actuated brake system for a heavy-duty vehicle is utilized, a prior art air disc braking system on a typical slider type of trailing arm beam axle/suspension system 20, is illustrated in FIG. 1 and described for exemplary purposes. The term “beam” will be used and apply equally to beams which extend either rearward or forward with respect to the front end of the heavy-duty vehicle. The illustrated axle/suspension system 20 is an integrated package of frame members, hangers, beams, axles, wheel end assemblies and a brake system having multiple individual brake assemblies. In the example illustrated in FIG. 1, the brake system is an air actuated brake system 22 that includes air actuated disc brake assemblies 24.

The exemplary slider axle/suspension system 20 is typically mounted to a pair of longitudinally-extending spaced-apart frame members (not shown) of the heavy-duty vehicle (not shown). The frame members may include various types of known frame components and/or configurations used on heavy-duty vehicles including primary frames, cross members, subframes and the like. The slider axle/suspension system 20 may include many types of frame structures and configurations, such as the relatively movable slider frame assembly 40. All of the various types of frame assemblies 40 will be referred to in this description as including a frame or frame members.

The illustrated slider axle/suspension system 20 includes a pair of longitudinally spaced axle/suspension assemblies, such as front or forward axle/suspension assembly 26a and rear or rearward axle/suspension assembly 26b. The axle/suspension assemblies 26a, 26b are substantially identical. Each of the axle/suspension assemblies 26a, 26b includes a substantially identical pair of transversely spaced and mirror image suspension assemblies 42. For sake of clarity and brevity, only one of the axle/suspension assemblies 26a, 26b and only one of the suspension assemblies 42 will be described and will equally apply to both axle/suspension assemblies and to both suspension assemblies.

Each suspension assembly 42 includes a hanger 44. Each suspension assembly 42 also includes a beam 46 that is pivotally connected to the hanger 44. The beam 46 may have any suitable configuration, such as a closed box-like cross-section or an inverted U-shape cross-section. The beam 46 is supported at a forward or first end portion for pivotal movement relative to the hanger 44 by a bushing assembly 50. The bushing assembly typically includes a bushing, pivot bolt, metal sleeves and washers, as is known. Each one of a pair og transversely extending axles 48a, 48b is fixed to a respective pair of the beams 46.

The beam 46 also includes a rearward or second end portion opposite the first end portion. The suspension assembly 42 includes an air spring 60 (only a relatively small portion of which is visible in FIG. 1) that is mounted on and extends between the second end portion of beam 46 and a frame member of the slider frame assembly 40. Each of the axle/suspension assemblies 26a, 26b may be supplied with shock absorbers (not shown) to provide damping. However, the air spring 60 may be designed and constructed to provide damping characteristics which could eliminate the need for shock absorbers.

The air actuated brake system 22 of the heavy-duty vehicle typically includes a plurality of the air actuated disc brake assemblies 24. Each of the air actuated disc brake assemblies 24 is mounted on a respective end of one of the axles 48a, 48b. Each of a first pair of air actuated disc brake assemblies 24 is mounted to respective end portions of the front or first axle 48a. For example, each of a second pair of air actuated disc brake assemblies 24 is mounted to respective end portions of the rear or second axle 48b.

A source of pressurized air in the form of a supply tank or reservoir 80 is supported by the slider frame assembly 40. Valve structure 82 is in fluid communication with the reservoir 80. The valve structure 82 selectively distributes pressurized air to each of the air actuated brake assemblies 24. The valve structure 82 may also serve as an anti-lock brake system modulator. Each of the air actuated disc brake assemblies 24 requires a predetermined minimum pressure to actuate. The minimum predetermined actuation pressure is substantially the same for each of the air actuated disc brake assemblies 24.

Front conduit lines 84a conduct pressurized air from the valve structure 82 to each of the air actuated brake assemblies 24 mounted to the front axle 48a. The left or driver side fluid conduit line 84a is located farther from the valve structure 82 than the right or passenger side fluid conduit line (also 84a) and, therefore, has a relatively longer length. Thus, if the inner diameters are the same for the front conduit lines 84a, the driver side front conduit line has a larger volume and proportionately less pressure that the passenger side front conduit line. Rear fluid conduit lines 84b conduct pressurized air from the valve structure 82 to each of the air actuated brake assemblies 24 mounted to the rear axle 48b. The rear fluid conduit lines 84b may be about the same length, although the left or driver side fluid conduit one may be located slightly farther from the valve structure 82 than the right or passenger fluid conduit line and, therefore, has a slightly longer length. Thus, if the inner diameters are the same for the rear conduit lines 84b, the driver side rear conduit line has a larger volume and proportionately less pressure that the passenger side rear conduit line. The rear conduit lines 84b are considerably longer than the front conduit lines 84a. The length of the left or driver side front fluid conduit line 84a is typically about two feet (4′) to about three feet (5′) and the right or passenger side front fluid conduit line is longer at about four feet (2′) to about five feet (3′). The lengths of each of the rear conduit lines 84b typically may be about seven feet (7′) to about eight feet (8′). When the valve structure 82 delivers air at the same pressure to all of the conduit lines 84a, 84b, the conduit lines having the larger volumes could take a relatively longer time to reach a pressure sufficient to actuate each air disc brake assembly resulting in unbalanced braking.

The conduit lines 84a and 84b typically have the same inner diameters. Thus, the conduit lines 84a and 84b each define a volume that pressurized air occupies. The relatively shorter front conduit lines 84a have a first volume from which the pressurized air acts. The relatively longer rear conduit lines 84b have a second volume from which the pressurized air acts. The second volume is considerably larger than the first volume. The control or service valve 82 initially delivers the same pressure from the single source reservoir 80 to each of the conduit lines 84a, 84b. It will, thus, be apparent that the pressure in the rear conduit lines 84b is less than the front conduit lines 84a. The initial pressures and volumes distributed to the front and rear conduit lines 84a and 84b, respectively, are different. These differences result in taking a relatively longer time to deliver the predetermined minimum pressure sufficient to actuate an air actuated brake assembly 24 that is located further away from the common valve structure 82 than a brake assembly that is located closer to the valve structure. The time it takes for the pressure in the various conduit lines 84a, 84b to reach the predetermined minimum pressure sufficient to actuate a brake assembly differs as a function of line lengths and inner diameters which establish the respective volumes.

Thus, generally the air actuated brake assemblies 24 located furthest from the common valve structure 82 have the longest conduit lines 84b and take a relatively longer time to actuate than the brake assemblies having the relatively shorter conduit lines 84a. Even an air actuated brake assembly 24 located on the same axle but further away from the valve structure 82 takes a relatively longer time to actuate than the brake assembly with relatively shorter conduit lines, such as the front conduit lines 84a. The timing differential for actuation can lead to uneven or unbalanced application of braking action of the air actuated brake assemblies 24 at least front-to-back. Possibly side-to-side unbalanced braking can happen if there are conduit lines with different lengths supplying brake assemblies located on the same axle. Such uneven application of braking action, in turn, can lead to uneven wear of components of the air actuated brake assemblies 24 and/or pulling to one side when brake assemblies are actuated. This is referred to as unbalanced braking which is less than optimally balanced braking. Unbalanced braking can lead to accelerated and uneven wear of brake system components and a thermal imbalance among the air actuated brake assemblies 24.

The known prior art air actuated brake systems have rather complex routing and packaging of the conduit lines requiring significant conduit line material. The complex routing may cause interference with other components of the heavy-duty vehicle and/or hinder troubleshooting of the known air actuated brake system. Such complex routing may have relatively high cost and impede efficient assembly. The complex routing may also yield decreased conduit line clearance, hinder caliper float and increased conduit line wear damage that could place the heavy-duty vehicle out-of-service.

The air actuated brake systems 22, such as that illustrated in FIG. 1, have been used in prior art in heavy-duty vehicle applications and satisfactorily perform their intended functions. However, a need exists for an improved air actuated brake system that eliminates or minimizes unbalanced braking during the operation of the heavy-duty vehicle.

The new and improved air actuated brake system, constructed according to an aspect of the subject disclosure, satisfies the needs and overcomes the shortcomings of the previously known air actuated brake systems. The new and improved air actuated brake system essentially accomplishes this by supplying substantially equal pressurized air to each of the air actuated brake assemblies at substantially the same time to balance braking action.

According to an aspect of the disclosed subject matter and by way of example, a new and improved air actuated brake system is provided. The new and improved air actuated brake system is intended for use on a heavy-duty vehicle in which the heavy-duty vehicle has a frame. Heavy-duty vehicles include trucks, tractor-trailers, trailers, buses and the like which typically have relatively large gross vehicle weights. For the purpose of convenience and brevity, reference will be made to a “heavy-duty vehicle”, with the understanding that such reference is by way of example and equally applies to trucks, tractor-trailers, trailers, buses and the like. Also, for the purpose of convenience and brevity, reference will be made to a “frame”, with the understanding that such reference is by way of example and equally applies to heavy-duty vehicle axle/suspension systems suspended from frames that include primary frames, movable subframes as used in a “slider”, non-movable subframes and the like.

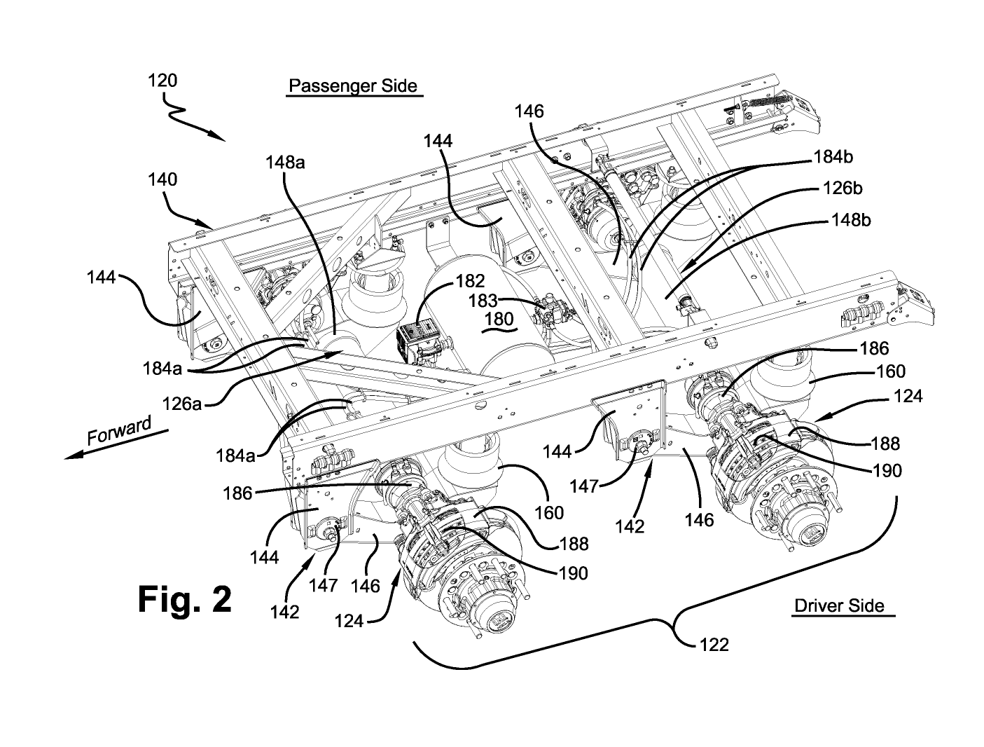

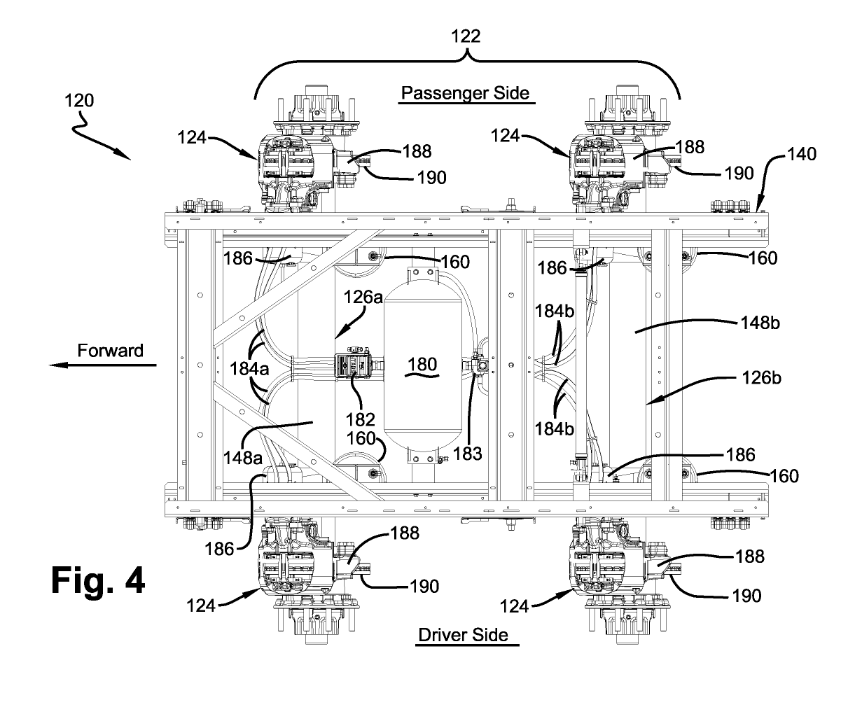

By way of example, an air actuated brake system for a heavy-duty vehicle axle/suspension system, according to an aspect of the subject disclosure, is utilized on a slider type of trailing arm beam axle/suspension system 120 (FIGS. 2-6). The use of the term “beam” will apply equally to beams which extend either rearward or forward from the pivot connection with respect to the front end of the heavy-duty vehicle. The slider axle/suspension system 120 is an integrated package of frame members, hangers, beams, axles, wheel end assemblies and brake systems. In FIGS. 2-6, the brake system is an air actuated brake system 122 that includes a plurality of air actuated disc brake assemblies 124. It will be appreciated that the air actuated brake system 122 may incorporate drum brake assemblies. The air actuated brake system 122 is designed to comply with United States regulation published as 49 CFR § 571.121—Standard No. 121 and its equivalents in other jurisdictions.

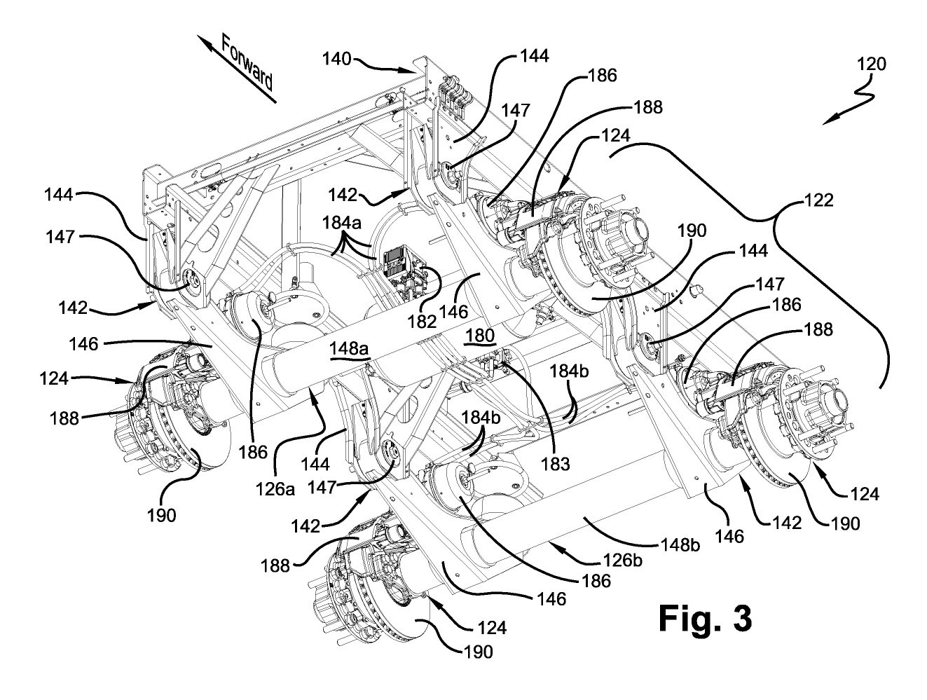

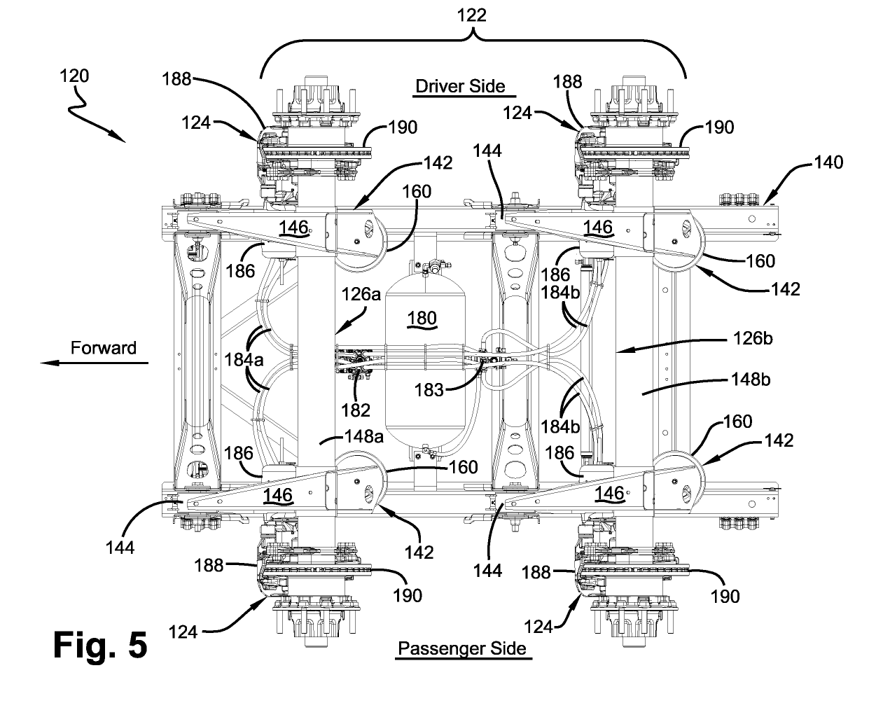

The slider axle/suspension system 120 may include many types of frame structures, such as a relatively movable frame assembly 140. All of the various types of frame assemblies 140 will be referred to in this description as including a frame or frame members. The slider axle/suspension system 120 is typically mounted on a pair of longitudinally-extending spaced-apart main or primary frame members (not shown) of the heavy-duty vehicle (not shown), as is known. The frame members may include various types of known frame components or configurations used for heavy-duty vehicles including primary frames, cross members and subframes. Each one of the pair of axle/suspension assemblies 126a, 126b generally includes a mirror image pair of transversely spaced suspension assemblies 142 (best seen in FIGS. 3 and 5). For the sake of clarity and brevity, only one of the axle/suspension assemblies 126a, 126b and only one of the suspension assemblies 142 will be described and will equally apply to both axle/suspension assemblies and to all suspension assemblies.

The slider axle/suspension system 120 includes a pair of longitudinally spaced axle/suspension assemblies 126 supported by frame members. The front or forward axle/suspension assembly is identified as 148a. The rear or rearward axle/suspension assembly is identified as 148b. As is known, the slider axle/suspension system 120 may include any suitable number of axle/suspension assemblies.

Each suspension assembly 142 includes a hanger 144 (FIGS. 2-3) which serves as a transition structure between the frame assembly 140 and other suspension assembly components. The suspension assembly 142 also includes a beam 146 that is pivotally connected to the hanger 144. The beam 146 may have any suitable configuration, such as a closed box-like cross-section or an inverted U-shape cross-section. The beam 146 is supported at a front or first end portion for pivotal movement relative to the hanger 144 by a bushing assembly 147 (FIG. 3). The bushing assembly 147 typically includes a bushing, pivot bolt, metal sleeves and washers, as is known. A transversely extending axle 148a, 148b is rigidly attached to a respective pair of transversely spaced beams 146. The front or forward axle is identified as 148a. The rear or rearward axle is identified as 148b.

The beam 146 also includes a rear or second end portion. The axle/suspension assembly 126a, 126b includes an air spring 160 that is mounted on and extends between the second end portion of beam 146 and a member of the frame assembly 140. The axle/suspension assembly 126a, 126b may be supplied with shock absorbers (not shown) to provide damping. The air spring 160 may be designed and constructed to provide damping characteristics which could partially or entirely eliminate the need for shock absorbers.

The air actuated brake system 122 of the heavy-duty vehicle may include a plurality of the air actuated disc brake assemblies 124. Each air actuated disc brake assembly 124 is mounted on a respective end of an axle 148a or 148b. Each of a first pair of air actuated disc brake assemblies 124 is mounted to a respective end portion of the front or first axle 148a. Each of a second pair of air actuated disc brake assemblies 124 is mounted to a respective end portion of the rear or second axle 148b. Each of the plurality of the air actuated disc brake assemblies 124 actuates when it receives a sufficient predetermined amount of air pressure. The predetermined minimum actuation pressure is substantially the same for each of the air actuated disc brake assemblies 124.

A source of pressurized air in the form of a tank or reservoir 180 is supported by the frame assembly 140. The pressurized air for the reservoir 180 is typically supplied by an air compressor (not shown) of the heavy-duty vehicle that is fluidly connected to the reservoir. The reservoir 180 is located between the axle/suspension assemblies 126a and 126b, and preferably a substantially equal distance from each of the axle/suspension assemblies and associated air actuated disc brake assemblies 124. The reservoir 180 includes inlet and outlet openings (not shown), as is known.

The reservoir 180 contains enough volume of pressurized air to operate all of the air actuated disc brake assemblies 124 and any other component of the heavy-duty vehicle that may require pressurized air, such as the air springs 160 and a tire inflation system (not shown). The reservoir 180 occupies volume in the range from about 0.8 ft³ to about 2.0 ft³. The reservoir 180 is typically charged with a pressure in the range of from about 70 psi to about 130 psi. The lower value in the pressure range typically occurs after and/or during actuation of the air actuated brake system 122. The air compressor has sufficient capacity to increase air pressure in the reservoir 180 from about 85 psi to about 100 psi within a relatively short predetermined time.

Control or service valve structure 182 is in fluid communication with the outlet opening of the reservoir 180. The valve structure 182 selectively distributes pressurized air to each of the air actuated brake assemblies 124. The outlet of the reservoir tank 180 and the valve structure 182 are preferably located adjacent one another and centrally to or a substantially equal distance away from the air actuated disc brake assemblies 124. Each of the air actuated disc brake assemblies 124 requires a predetermined minimum pressure in order to actuate. For example, the sufficient predetermined minimum amount of actuation air pressure may be in the range of from about 3 psi to about 7 psi. Drum brakes typically may actuate at about 3 psi. The valve structure 182 may also serve as an anti-lock brake system modulator.

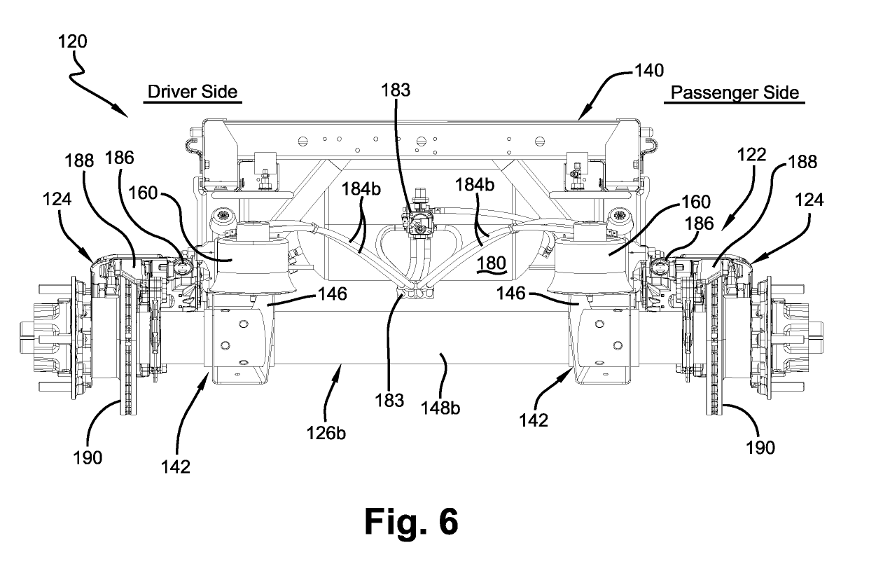

Each of the air actuated brake assemblies 124 includes an actuator 186 (FIGS. 2-6) with a brake chamber that activates the brakes upon receiving the predetermined minimum pressurized air. The actuator 186 is supported by a caliper 188 of brake assembly 124. Each actuator 186 is positioned above the longitudinal center line of the respective axle 148a, 148b (FIG. 6). Locating the actuators 186 above the longitudinal center line of the axles 148a, 148b may provide an enhancement by allowing the shortening and evening of the conduit lines 184a, 184b relative to prior art conduit lines. Locating the actuators 186 above the longitudinal center line of the axles 148a, 148b may also protect the actuators from contact by road debris.

The actuator 186 causes movement of pistons (not shown) within the caliper 188 upon receiving the sufficient predetermined amount of pressurized air. Each one of a pair of opposing disc brake pads (not shown) includes a friction material. Disc brake pads with friction material are positioned adjacent respective pistons and seated in a carrier portion (not shown) of the caliper 188. Upon actuation, the pistons and an associated reaction arm cooperate to move the brake pads against a rotor 190 in response to receiving the predetermined minimum pressurized air. The disc brake pads are forced against opposite sides of the rotor 190 to slow and/or stop rotation of the rotor, thereby slowing and/or stopping movement of the heavy-duty vehicle.

Front conduit lines 184a conduct pressurized air from, and enable fluid communication between, the valve structure 182 and the actuator 186 (FIGS. 2-5) of each brake assembly 124 mounted on the front axle 148a. Each of the front conduit lines 184a comprises a pair of pneumatic supply lines. One of the pair of front conduit lines 184a supplies actuating air pressure to the brake chamber of the actuator 186 of an air actuated brake assembly 124. The other of the pair of front conduit lines 184a supplies air pressure to disengage or deactivate a parking brake of the air actuated brake assembly 124. Control of pressurized air to actuate the brake assembly 124 is accomplished by the valve structure 182. Control of pressurized air to deactivate the parking brake is accomplished by spring brake valve structure 183. The lengths of the front conduit lines 184a from the respective valve structures 182, 183 to both of the brake assemblies 124 on the front axle 148a are substantially the same.

Rear conduit lines 184b conduct pressurized air from, and allow fluid communication between, the valve structure 182 and an actuator 186 of each air actuated brake assembly 124 mounted on the rear or second axle 148b. Each of the rear conduit lines 184b leading to a brake assembly 124 comprises a pair of pneumatic supply lines. One of the pair of rear conduit lines 184b supplies the predetermined minimum actuating air pressure to a brake chamber of the actuator 186. The other of the pair of rear conduit lines 184b supplies air pressure to disengage or deactivate the parking brake of the air actuated brake assembly 124. The control of supplying predetermined minimum pressurized air to actuate the air actuated brake assembly 124 is provided by the valve structure 182. The control of supplying pressurized air to deactivate the parking brake is accomplished by the spring brake valve structure 183. The lengths of the rear conduit lines 184b from the respective valve structures 182, 183 to the air actuated disc brake assemblies 124 on the rear or second axle 148b are substantially the same. The lengths of the rear conduit lines 184b approximate the lengths of the front conduit lines 184a.

The conduit lines 184a and 184b may have the same inner diameters in the range of from about 0.352 inch to about 0.398 inch, and preferably about 0.375 inch. The lengths of each of the front conduit lines 184a are in the range of from about three feet (3′) to about four feet (4′), and preferably about three and a half feet (3.5′). The lengths of each of the rear conduit lines 184b are typically in the range of from about three and a half feet (3.5′) to about four and a half feet (4.5′), and preferably about four feet (4′). Thus, it can be seen that the lengths of the conduit lines 184a and 184b are substantially the same or at the most do not vary by more than 50 percent from one another, preferably in the range of from about 30 percent to about 25 percent difference and more preferably no more than about 15 percent difference. It may be preferable that the lengths of the conduit lines 184a and 184b are the same if practical. This would aid in manufacturing and inventory control since a single length of the conduit lines 184a and 184b would be able to be used throughout the heavy-duty vehicle.

There is another way of describing how the concept of the subject disclosure accomplishes balanced braking. That is, instead of providing substantially equal lengths of the conduit lines 184a and 184b, a plurality of conduits having substantially equal volume is provided. This results from the conduit lines 184a and 184b having substantially equal lengths and substantially equal inner diameters. However, it is contemplated that the conduit lines 184a and 184b could be provided with different inside diameters and/or different lengths to achieve the substantially equal volumes. For example, the front conduit lines 184a may have an inner diameter greater than the inner diameter of longer rear conduit lines 184b.

The conduit lines 184a and 184b each define a volume that pressurized air occupies. Each of the front conduit lines 184a contains a first volume of which the pressurized air may occupy and be directed to the air actuated disc brake assembly 124. Each of the rear conduit lines 184b contains a second volume of which the pressurized air may occupy and be directed to the air actuated disc brake assembly 124. The first volume is substantially equal to the second volume. The respective volumes of the conduit lines 184a and 184b are substantially the same or at the most do not vary by more than 50 percent from one another, preferably in the range of from about 30 percent to about 25 percent difference and more preferably no more than about 15 percent difference. Thus, the first and second volumes in conduit lines 184a and 184b, respectively, supply a substantially equal amount of the predetermined minimum pressure sufficient to actuate each brake assembly 124 at substantially the same time to balance braking action.

An example performance comparison of a typical prior art air actuated brake system to the air actuated brake system 122 of the heavy-duty vehicle, according to an aspect of the subject disclosure, is described. The prior art air actuated brake system and the air actuated brake system 122 were each tested at the same conditions. Each air actuated brake system had 60 psi of pressure applied to its control or service valve structure. Pressure in each of four conduits leading to a respective actuator was measured at a particular time after the air actuated brake systems were exposed to the applied pressure. The table below represents the difference of the highest to lowest pressure measured among the four conduits of each respective system at a particular time. It is apparent that the air actuated brake system 122 of the subject disclosure has a more evenly distributed pressure among all of its conduits than that of the typical prior art air actuated brake system. Thus, the supply a substantially equal amount of pressure at substantially the same time of the air actuated brake system 122 of the subject disclosure enables improved balance braking. While results from only one exemplary test at 60 psi of applied pressure are presented, other pressures were applied to each air actuated brake system with similar results.

| | | air actuated brake |
|---|---|---|
| time (sec.) | prior art (in Δ psi) | system 122 (in Δ psi) |
| 0.10 | 0.87 | 0.69 |
| 0.15 | 5.54 | 3.75 |
| 0.20 | 4.94 | 2.74 |
| 0.25 | 2.61 | 0.92 |
| 0.30 | 1.24 | 0.64 |

Another example performance comparison of a typical prior art air actuated brake system to the air actuated brake system 122 of the heavy-duty vehicle, according to the subject disclosure, is described. The prior art air actuated brake system and the air actuated brake system 122 were each tested at the same conditions. Each air actuated brake system had 60 psi of pressure applied to its control or service valve structure. The time required for each of the four conduits leading to a respective actuator to reach a particular pressure was measured. The time delay from fastest actuation to slowest actuation to reach 5 psi is shown in the table below. It is apparent that the air actuated brake system 122 of the subject disclosure takes less time to achieve a substantially evenly distributed pressure among all of its conduits than that of the typical prior art air actuated brake system. Thus, the supply a substantially equal amount of pressure at substantially the same time of the air actuated brake system 122 of the subject disclosure enables improved balance braking. While results from only one exemplary test at 60 psi of applied pressure are presented, other pressures were applied to each air actuated brake system with similar results.

| | prior art (time delay | air actuated brake system 122 |
|---|---|---|
| | from fastest actuation | (time delay from fastest |
| pressure | to slowest actuation in | actuation to slowest actuation |
| (psi) | second) | in second) |
| 5 | 0.015 | 0.010 |
| 10 | 0.010 | 0.005 |
| 20 | 0.010 | 0.010 |
| 30 | 0.015 | 0.005 |
| 40 | 0.010 | 0.005 |
| 50 | 0.015 | 0.005 |
| 60 | 0.005 | 0.005 |

The time it takes for the pressure in the various conduit lines 184a and 184b to reach the predetermined minimum pressure sufficient to actuate a respective brake assembly 124 is substantially the same. The air actuated disc brake assemblies 124 located furthest or greatest distance from the common valve structure 182, and therefore the longest conduit lines, are actuated at about the same time as the brake assemblies with the shortest conduit lines. Nearly simultaneous actuation timing of brake actuation may be due to the substantially equalized volumes and/or pressures resulting from “tuning” the volume and pressure of all the conduit lines by varying inside diameters and lengths. This provides a relatively even or balanced application of braking action of the brake assemblies 124 front-to-back and side-to-side. Such even or balanced application of braking action provides relatively even braking and eliminates or minimizes pulling to one side when brake assemblies 124 are actuated. This balanced braking may lead to relatively even wear of brake system components and substantially even thermal balance among the brake assemblies 124 and components.

The new and improved air actuated brake system 120 for a heavy-duty vehicle is provided according to at least one aspect of the disclosed subject matter. The air actuated brake system 120 of the disclosed subject matter overcomes limitations, disadvantages, drawbacks and deficiencies associated with previously known air actuated brake systems. The air actuated brake system 120 provides relatively balanced braking compared to previously known air actuated brake systems. The air actuated brake system 120 has conduit line lengths that are shortened and/or substantially equal to provide more of a balanced braking effect by actuating all of the brake assemblies at substantially the same time. The air actuated brake system 120 also has conduit line volumes that are substantially equal to provide more of a balanced braking effect by actuating all of the brake assemblies at substantially the same time. The actuated brake system 120 may result in less wear and yield a thermally balanced brake system. The air actuated brake system 120 applies to all types of air actuated brake systems including, for example, disc brake systems and drum brake systems and may be employed with any suitable frame type, such as a slider box or primary frame.

The air actuated brake system 120 may offer reduced routing complexity and packaging of the conduit lines. Reduced complexity of conduit line routing may advantageously avoid interference with other components of the heavy-duty vehicle and occupy less valuable space beneath the heavy-duty vehicle. Substantially equal conduit line lengths and volumes further may minimize or eliminate the opportunity for caliper restriction in an air disc brake system. The simplified routing may cause less interference with troubleshooting the brake system. The simplified routing may also increase conduit line clearance and decreases conduit line wear. A shortening of conduit line lengths and/or substantially equalizing conduit line lengths, volumes and complexity also may reduce material, component and assembly costs.

From the above description of at least one aspect of the disclosed subject matter, those skilled in the art will perceive improvements, changes and modifications. Such improvements, changes and modifications within the skill of the art are intended to be encompassed by the disclosed subject matter and claims.

In the description, certain terms have been used for brevity, clarity and understanding. No unnecessary limitations are to be implied from those terms because such terms are used for descriptive purposes and are intended to be broadly construed. It is understood that this description and illustration is by way of example and not by way of limitation and that the scope of the subject disclosure is not limited to the exact details shown or described.

Certain terminology is used for purposes of reference only, and thus is not intended to be limiting. For example, terms such as “forward”, “rearward”, “above” and “below” refer to directions illustrated in the drawings and referred to in the description. Terms such as “front”, “rear”, “longitudinal” and “transverse”, describe the orientation of portions of the component within a consistent but arbitrary reference made clear by the text and the associated drawings. Such terminology may include the words specifically mentioned above, derivatives thereof, and words of similar import. Similarly, the terms “first”, “second” and other such numerical terms referring to structures, pressures and/or volume do not imply a sequence or order unless clearly stated in the description.

What is claimed is:

1. An air actuated brake system for use on a heavy-duty vehicle in which the heavy-duty vehicle has a frame, the air actuated brake system comprising:
a first pair of air actuated brake assemblies, each of the first pair of air actuated brake assemblies mounted to a respective end portion of a first axle, the first axle being supported by the frame;
a second pair of air actuated brake assemblies, each of the second pair of air actuated brake assemblies mounted to a respective end portion of a second axle, the second axle being supported by the frame;
a source of pressurized air;
valve structure in fluid communication with the source of pressurized air, the first pair of air actuated brake assemblies and the second pair of air actuated brake assemblies, the valve structure being located substantially equidistant to each of the air actuated brake assemblies; and
conduits of substantially equal length, each of the conduits fluidly connecting the valve structure with a respective one of the first pair of air actuated brake assemblies and a respective one of the second pair of air actuated brake assemblies to actuate the air actuated brake assemblies.

2. The air actuated brake system of claim 1 wherein substantially equal pressurized air is supplied to each of the air actuated brake assemblies at substantially the same time to balance braking.

3. The air actuated brake system of claim 2 wherein the pressure differential among all of the plurality of conduits is less than 0.80 psi at a time of 0.10 second after the start of a 60 psi pressure being applied from the valve structure to the conduits.

4. The air actuated brake system of claim 3 wherein the pressure differential among all of the plurality of conduits is less than 0.70 psi at a time of 0.10 second after the start of a 60 psi pressure being applied from the valve structure to the conduits.

5. The air actuated brake system of claim 2 wherein the pressure differential among all of the plurality of conduits is less than 4.50 psi at a time of 0.20 second after the start of a 60 psi pressure being applied from the valve structure to the conduits.

6. The air actuated brake system of claim 5 wherein the pressure differential among all of the plurality of conduits is less than 3.00 psi at a time of 0.20 second after the start of a 60 psi pressure being applied from the valve structure to the conduits.

7. The air actuated brake system of claim 2 wherein the pressure differential among all of the plurality of conduits is less than 1.00 psi at a time of 0.30 second after the start of a 60 psi pressure being applied from the valve structure to the conduits.

8. The air actuated brake system of claim 7 wherein the pressure differential among all of the plurality of conduits is less than 0.75 psi at a time of 0.30 second after the start of a 60 psi pressure being applied from the valve structure to the conduits.

9. The air actuated brake system of claim 2 wherein the time delay from fastest actuation to slowest actuation when a 60 psi pressure being applied from the valve structure to all of the plurality of conduits for all of the plurality of conduits to reach 5 psi is less than 0.0125 second.

10. The air actuated brake system of claim 9 wherein the time delay from fastest actuation to slowest actuation when a 60 psi pressure being applied from the valve structure to all of the plurality of conduits for all of the plurality of conduits to reach 5 psi is 0.010 second or less.

11. The air actuated brake system of claim 1 wherein in each of the conduits having substantially equal inner diameters.

12. The air actuated brake system of claim 1 wherein the frame supporting the first and second axles comprises a slider box.

13. The air actuated brake system of claim 1 wherein each of the air actuated brake assemblies comprises a disc brake assembly.

14. The air actuated brake system of claim 1 wherein each of the of air actuated brake assemblies comprises a drum brake assembly.

15. The air actuated brake system of claim 1 wherein the source of pressurized air comprises a reservoir tank supported by the frame and has an outlet located adjacent the valve structure and substantially central to each of the air actuated brake assemblies.

16. The air actuated brake system of claim 1 wherein substantially equal volumes of pressurized air is supplied to each of the air actuated brake assemblies at substantially the same time to balance braking.

17. A slider suspension system for a heavy-duty vehicle having an air actuated brake system, the system comprising:
a frame;
a first pair of air actuated brake assemblies, each of the first pair of air actuated brake assemblies being mounted to respective end portions of a first axle, the first axle being supported by the frame;
a second pair of air actuated brake assemblies, each of the second pair of air actuated brake assemblies being mounted to respective end portions of a second axle, the second axle being supported by the frame;
a source of pressurized air;
valve structure in fluid communication with the source of pressurized air, the valve structure being in fluid communication with and located substantially equidistant to the air actuated brake assemblies; and
conduits of substantially equal length, each of the conduits fluidly connecting the valve structure with each of the first pair of air actuated brake assemblies and each of the second pair of air actuated brake assemblies to actuate the air actuated brake assemblies by supplying substantially equal pressurized air to each of the air actuated brake assemblies at substantially the same time to balance braking.

18. The slider suspension system of claim 17 wherein the lengths of the conduits are within about 50 percent of one another.

19. The slider suspension system of claim 17 wherein in each of the conduits having substantially equal inner diameters.

20. The slider suspension system of claim 17 wherein the length of each of a first pair of conduits is in a range of about 3.0 feet to about 4.0 feet and the length of each of a second pair of conduits is in the range of about 3.5 feet to about 4.5 feet.

21. The slider suspension system of claim 17 wherein each of the air actuated brake assemblies comprises a disc brake assembly.

22. The slider suspension system of claim 17 wherein each of the air actuated brake assemblies comprises a drum brake assembly.

23. The slider suspension system of claim 17 wherein the source of pressurized air comprises a reservoir tank supported by the frame and has an outlet located intermediate the first and second axles and adjacent to the valve structure.

24. An air actuated brake system for use on a heavy-duty vehicle that includes a frame, the air actuated brake system comprising:
at least one axle supported by the frame;
a pair of air actuated brake assemblies, each of the pair of air actuated brake assemblies being mounted to respective end portions of the axle;
a source of pressurized air;
valve structure in fluid communication with the source of pressurized air, the valve structure located substantially equidistant to and in fluid communication with each of the pair of air actuated brake assemblies; and
a pair of conduits of substantially equal length, each of the conduits fluidly connecting the valve structure with respective ones of the pair of air actuated brake assemblies, whereby sufficient pressurized air is supplied to each of the air actuated brake assemblies at substantially the same time to actuate the pair of air actuated brake assemblies with substantially balanced braking.

25. The air actuated brake system of claim 24 wherein the sufficient pressurized air is supplied at equal pressures.

26. The air actuated brake system of claim 24 wherein each of the conduits having substantially equal inner diameters.

27. The air actuated brake system of claim 24 further including a second axle supported by the frame, a second set of conduits of substantially equal lengths, each of the conduits fluidly connecting the valve structure with a respective one of a second pair of air actuated brake assemblies mounted to respective end portions of the second axle, whereby sufficient pressurized air is supplied to all of the air actuated brake assemblies at substantially the same time to actuate the air actuated brake assemblies with substantially balanced braking.

28. The air actuated brake system of claim 27 wherein the length of the conduits is within 50 percent of the all other conduits.

29. The air actuated brake system of claim 27 wherein the length of each of the conduits for the first pair of air actuated brake assemblies is in the range of about 3.0 feet to about 4.0 feet and the length of each of the conduits for the second pair of air actuated brake assemblies is in the range of about 3.5 feet to about 4.5 feet.

30. The air actuated brake system of claim 27 wherein each of the air actuated brake assemblies comprises a disc brake assembly.

31. The air actuated brake system of claim 27 wherein each of the air actuated brake assemblies comprises a drum brake assembly.

32. The air actuated brake system of claim 24 wherein the source of pressurized air comprises a reservoir tank supported by the frame and has an outlet located intermediate the first and second axles and adjacent to the valve structure.

33. A slider suspension system assembly for a heavy-duty vehicle having an air actuated brake system, the slider suspension system comprising:
a frame;
a first pair of air actuated brake assemblies, each of the first pair of air actuated brake assemblies being mounted to respective end portions of a first axle, the first axle being supported by the frame;
a second pair of air actuated brake assemblies, each of the second pair of air actuated brake assemblies bring mounted to respective end portions of a second axle, the second axle being supported by the frame;
a source of pressurized air;
valve structure in fluid communication with the source of pressurized air, the valve structure being located substantially equidistant to and in fluid communication with each of the air actuated brake assemblies; and
a plurality of conduits, each of the plurality of conduits having substantially equal volumes and fluidly connecting the valve structure with each of the first pair of air actuated brake assemblies and each of the second pair of air actuated brake assemblies to actuate all of the air actuated brake assemblies by supplying the substantially equal volume of air at the same pressure to each of the air actuated brake assemblies at substantially the same time to balance braking.

34. The slider suspension system of claim 33 wherein each of the plurality of conduits have substantially equal inner diameters.

35. The slider suspension system of claim 33 wherein each of the plurality of conduits have substantially equal lengths.

36. A slider suspension system for a heavy-duty vehicle having an air actuated brake system, the slider suspension system comprising:
a frame;
a first pair of air actuated brake assemblies, each of the first pair of air actuated brake assemblies being mounted to respective end portions of a first axle, the first axle being supported by the frame;
a second pair of air actuated brake assemblies, each of the second pair of air actuated brake assemblies bring mounted to respective end portions of a second axle, the second axle being supported by the frame;
a source of pressurized air;
valve structure in fluid communication with the source of pressurized air, the valve structure being located substantially equidistant from and in fluid communication with each of the air actuated brake assemblies; and
a plurality of conduits having substantially equal inner diameters, each of the plurality of conduits fluidly connecting the valve structure with each of the first pair of air actuated brake assemblies and each of the second pair of air actuated brake assemblies to actuate the air actuated brake assemblies by supplying substantially equal pressure air to each of the air actuated brake assemblies at substantially the same time to balance braking.

37. The slider suspension system of claim 36 wherein each of the plurality of conduits have substantially equal volume.

38. The slider suspension system of claim 36 wherein each of the plurality of conduits have substantially equal lengths.

39. An air actuated brake system for use on a heavy-duty vehicle in which the heavy-duty vehicle has a frame, the air actuated brake system comprising:
a first pair of air actuated brake assemblies, each of the first pair of air actuated brake assemblies mounted to a respective end portion of a first axle, the first axle being supported by the frame;
a second pair of air actuated brake assemblies, each of the second pair of air actuated brake assemblies mounted to a respective end portion of a second axle, the second axle being supported by the frame;
a source of pressurized air;
valve structure in fluid communication with the source of pressurized air, the first pair of air actuated brake assemblies and the second pair of air actuated brake assemblies, the valve structure being located substantially equidistant to each of the air actuated brake assemblies; and
conduits of substantially equal volume, each of the conduits fluidly connecting the valve structure with a respective one of the first pair of air actuated brake assemblies and a respective one of the second pair of air actuated brake assemblies to actuate the air actuated brake assemblies.

40. The air actuated brake system of claim 39 wherein substantially equal pressurized air is supplied to each of the air actuated brake assemblies at substantially the same time to balance braking.

41. The air actuated brake system of claim 39 wherein in each of the conduits have substantially equal inner diameters.
